(19) United States
(12) Patent Application Publication
(10) Pub. No.: US 2011/0252347 A1
(43) Pub. Date: Oct. 13, 2011

(54) INFORMATION PROCESSING APPARATUS, METHOD OF CONTROLLING THE SAME, AND STORAGE MEDIUM

(75) Inventor: Takaharu Osawa, Yokohama-shi (JP)

(73) Assignee: CANON KABUSHIKI KAISHA, Tokyo (JP)

(21) Appl. No.: 13/059,252

(22) PCT Filed: Nov. 17, 2010
(86) PCT No.: PCT/JP2010/070950

§ 371 Date: Feb. 16, 2011

(30) Foreign Application Priority Data
Dec. 14, 2009 (JP) 2009-283436

(51) Int. Cl. G06F 3/048

(52) U.S. Cl. 715/765

(57) ABSTRACT

This invention provides an information processing apparatus capable of, on an operation screen that can be customized in accordance with user's need, customizing the operation buttons of an application provided by an external apparatus, and a method of controlling the same. To accomplish this, the information processing apparatus displays a registration button to add, to a custom menu, custom buttons to be executed based on the current setting information of the currently running application during display of the operation screen of a Web application. When the registration button is pressed, the information processing apparatus manages button data and action data in association with each other as the information of custom buttons to be added to the custom menu. When the user instructs to display the custom menu, the information processing apparatus generates the custom menu including the custom buttons using the button data, and displays it.

### TECHNICAL FIELD

The present invention relates to an information processing apparatus capable of using an external application provided by an external apparatus, a method of controlling the same, and a storage medium.

### BACKGROUND ART

An information processing apparatus such as a PC is known to be connected to a Web server on a network and display an operation screen provided by the Web server on a Web browser installed in the information processing apparatus. In this case, the Web browser on the information processing apparatus requests the operation screen from the Web server, and a Web application on the Web server sends, to the information processing apparatus, an HTML file to display the operation screen on the Web browser in accordance with the request from the information processing apparatus. The Web browser on the information processing apparatus analyzes the received HTML file, and displays the operation screen based on the description of the HTML file as a Web browser screen. Additionally, when the user inputs an instruction via the operation screen displayed on the Web browser, the Web browser notifies the Web server of the input instruction. Upon receiving the notification, the Web application on the Web server executes processing in accordance with the input instruction.

Recently, some MFPs (Multi Function Peripherals) equipped with a scanner and a printer also include a Web browser as described above. The MFP displays, on its Web browser, an operation screen provided by a Web server in accordance with the above-described procedure, and receives various kinds of user instructions.

In Japanese Patent Laid-Open No. 2002-215573, a Web server distributes screen information including buttons to be used to select instruction contents to an information processing apparatus. More specifically, the user of the information processing apparatus selects a button on the screen displayed based on the distributed screen information, thereby displaying a Web browser screen or activating an application in accordance with instruction contents associated with the selected button. This allows the user to easily invoke frequently used functions by using the distributed buttons.

However, the above-described prior art has the following problems. For example, the contents of the buttons included in the distributed screen are limited to those registered by the administrator of the Web server in advance. In addition, the Web browser screen displayed upon selecting a button cannot display input items in which settings of, for example, an address, name, and number of copies are already input. That is, in the above-described prior art, the screen provided by the Web server can hardly display a screen customized in accordance with the demand of the user who uses the Web browser.

### SUMMARY OF INVENTION

The present invention enables realization of an information processing apparatus capable of customizing the operation buttons of an application provided by an external apparatus on an operation screen that can be customized in accordance with the user's demand, a method of controlling the same, and a storage medium.

One aspect of the present invention provides an information processing apparatus capable of using an external application provided by an external apparatus, characterized by comprising: first display control means for displaying, on a display unit, an operation screen of the external application and a registration button configured to register, in a custom menu, a custom button that causes a currently running application to execute processing based on current setting information; storage means for, when the registration button is pressed, analyzing the setting information currently input to the operation screen and storing, in a storage device, button data concerning the custom button and action data concerning the current setting information in association with each other; and second display control means for, upon receiving an instruction to display the custom menu, reading out the button data and the action data from the storage device, generating the custom menu including the custom button corresponding to the readout button data and action data, and displaying the custom menu on the display unit.

Another aspect of the present invention provides a method of controlling an information processing apparatus capable of using an external application provided by an external apparatus, characterized by comprising: causing first display control means to display, on a display unit, an operation screen of the external application and a registration button configured to register, in a custom menu, a custom button that causes a currently running application to execute processing based on current setting information; causing storage means to, when the registration button is pressed, analyze the setting information currently input to the operation screen and store, in a storage device, button data concerning the custom button and action data concerning the current setting information in association with each other; and causing second display control means to, upon receiving an instruction to display the custom menu, read out the button data and the action data from the storage device, generate the custom menu including the custom button corresponding to the readout button data and action data, and display the custom menu on the display unit.

Still another aspect of the present invention provides a computer-readable storage medium storing a computer program which causes a computer to execute an information processing apparatus control method.

Further features of the present invention will be apparent from the following description of exemplary embodiments with reference to the attached drawings.

### BRIEF DESCRIPTION OF DRAWINGS

FIG. 1 is a view showing the overall configuration of an information processing system 100 according to the first embodiment;

FIG. 2 is a block diagram showing an example of the arrangement of an MFP 101 according to the first embodiment;

FIG. 3 is a block diagram showing an example of the arrangement of a Web server 103 according to the first embodiment;

FIG. 4 is a block diagram showing an example of the control arrangement of the information processing system 100 according to the first embodiment;

FIG. 5 is a view showing examples of the data formats of button data 501 and action data 510 according to the first embodiment;

FIG. 6 is a view showing the user interface of a copy Web application according to the first embodiment;

FIG. 7 is a flowchart illustrating the procedure of button registration processing according to the first embodiment;

FIG. 8 is a view showing an operation screen 800 of a custom menu 470 according to the first embodiment;

FIG. 9 is a flowchart illustrating the procedure of button execution processing according to the first embodiment;

FIG. 10 is a view showing an operation screen 1000 of a custom menu 470 according to the second embodiment;

FIG. 11 is a flowchart illustrating the procedure of button deletion processing according to the second embodiment; and

FIG. 12 is a flowchart illustrating the procedure of button delete determination processing according to the second embodiment.

### DESCRIPTION OF EMBODIMENTS

Embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

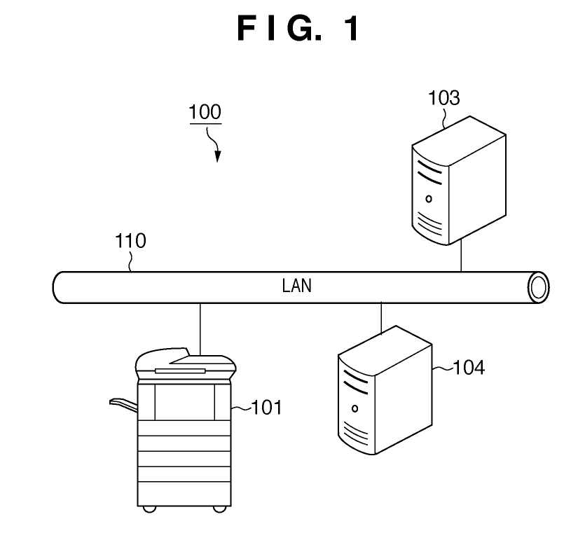

The first embodiment of the present invention will be described below with reference to FIGS. 1 to 9. In this embodiment, an example will be described in which an MFP that is an example of an information processing apparatus requests an operation screen from a Web application using a Web browser. After that, the MFP registers, as buttons, the input values of the input items of the Web browser screen displayed on the provided operation screen.

<Configuration of Information Processing System>

The overall configuration of an information processing system 100 according to the embodiment will be described first with reference to FIG. 1. An MFP 101 and Web servers 103 and 104 are connected to a LAN 110 so as to be communicable with each other. An FTP (File Transfer Protocol) server (not shown) is also provided on the LAN 110 so that the MFP 101 can send image data to the FTP server by FTP. Note that FIG. 1 illustrates an example of the information processing system according to the embodiment so there is no intention to limit the types and number of apparatuses.

<Arrangement of MFP>

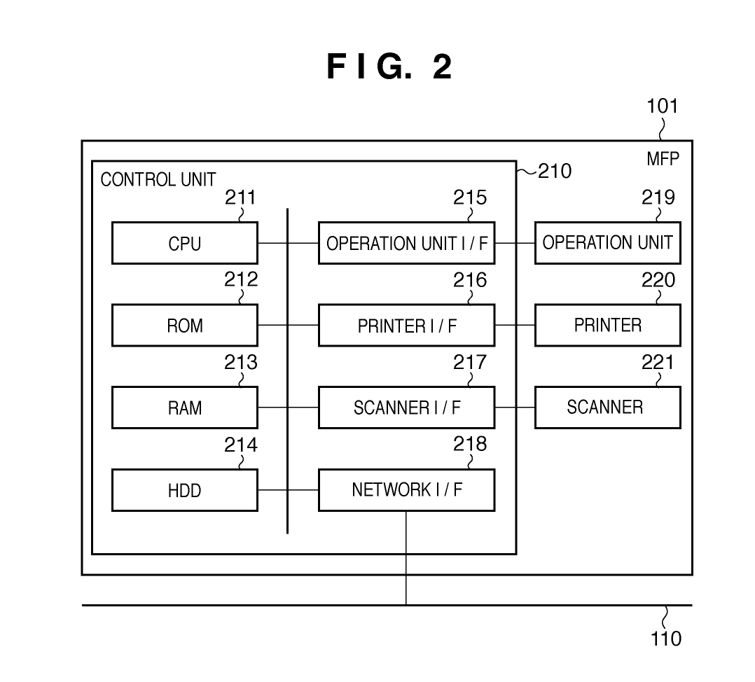

An example of the arrangement of the MFP 101 will be explained next with reference to FIG. 2. The MFP 101 includes a control unit 210, operation unit 219, printer 220, and scanner 221. The control unit 210 includes a CPU 211, ROM 212, RAM 213, HDD 214, operation unit I/F 215, printer I/F 216, scanner I/F 217, and network I/F 218.

The control unit 210 generally controls the operation of the MFP 101. The CPU 211 reads out control programs stored in the ROM 212, and executes various kinds of control processing such as read control and send control. The RAM 213 is used as a temporary storage area such as the main memory or work memory of the CPU 211. The HDD 214 stores image data, various programs, and various information tables to be described later.

The operation unit I/F 215 connects the operation unit (display unit) 219 to the control unit 210. The operation unit 219 includes a keyboard, a liquid crystal display unit having a touch panel function, and the like. The MFP 101 also has a Web browser function to be described later. The Web browser of the MFP 101 analyzes an HTML file (screen information) received from the Web server 103, and displays an operation screen based on the description of the received HTML file on the operation unit 219.

The printer I/F 216 connects the printer 220 to the control unit 210. Image data to be printed by the printer 220 is transferred from the control unit 210 to the printer 220 via the printer I/F 216, and the printer 220 prints it on a printing medium. The scanner I/F 217 connects the scanner 221 to the control unit 210. The scanner 221 reads an image on an original to generate image data, and inputs it to the control unit 210 via the scanner I/F 217. The network I/F 218 connects the control unit 210 (MFP 101) to the LAN 110. The network I/F 218 sends image data or information to an external apparatus (for example, Web server 103) on the LAN 110, or receives various kinds of information from the external apparatus on the LAN 110.

<Arrangement of Web Server>

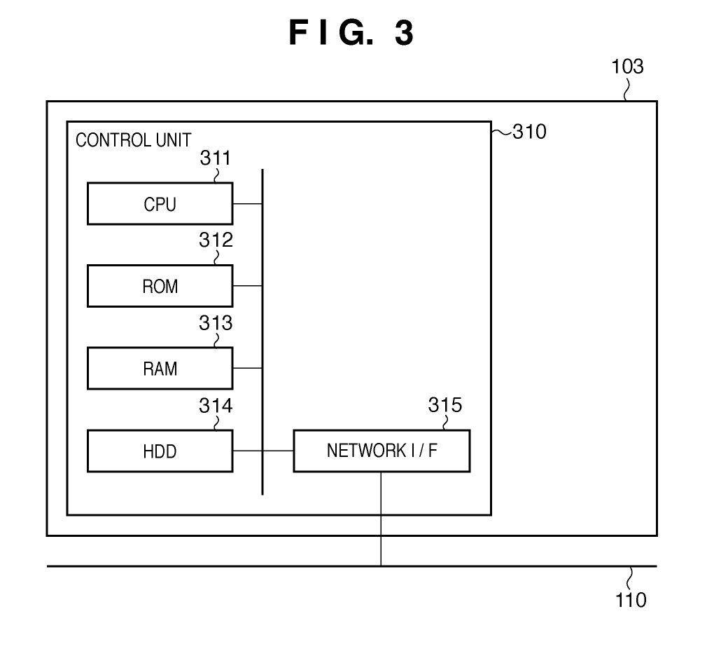

An example of the arrangement of the Web server 103 will be described next with reference to FIG. 3. Note that the Web server 104 has the same arrangement as that of the Web server 103, and a description thereof will be omitted. The Web server 103 includes a control unit 310. The control unit 310 includes a CPU 311, ROM 312, RAM 313, HDD 314, and network I/F 315.

The control unit 310 generally controls the operation of the Web server 103. The CPU 311 reads out control programs stored in the ROM 312, and executes various kinds of control processing. The RAM 313 is used as a temporary storage area such as the main memory or work area of the CPU 311. The HDD 314 stores image data, various programs, and various information tables to be described later. The network I/F 315 connects the control unit 310 (Web server 103) to the LAN 110. The network I/F 315 sends/receives various kinds of information to/from another apparatus on the LAN 110.

<Control Arrangement of Information Processing System>

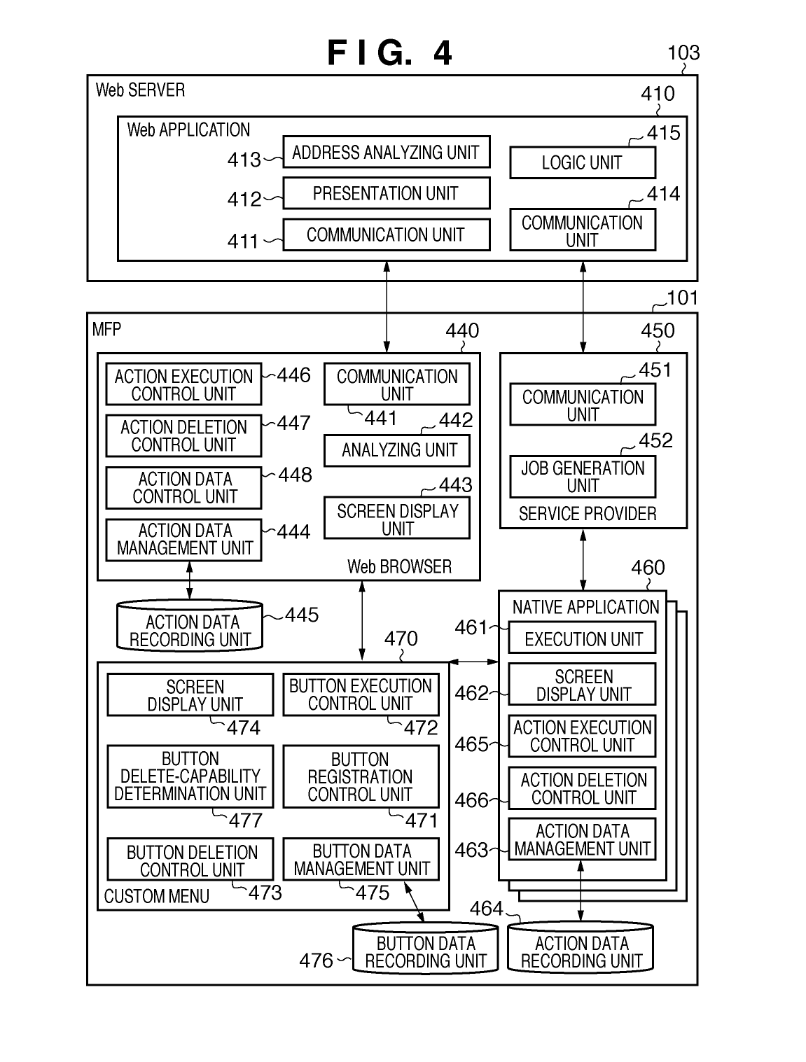

An example of the control arrangement of the entire information processing system 100 will be described next with reference to FIG. 4. The functional units shown in FIG. 4 are implemented by causing the CPUs 211 and 311 provided in the MFP 101 and the Web server 103, respectively, to execute control programs. The MFP 101 includes a Web browser 440, service provider 450, native applications 460, custom menu 470, action data-recording units 445 and 464, and button data-recording unit 476. The Web server 103 includes a Web application 410.

Each native application 460 includes an execution unit 461, screen display unit 462, action data management unit 463, action execution control unit 465, and action deletion control unit 466. Examples of the native applications 460 are a copy application, scan application, and send application that execute copy processing, scan processing, and scan image distribution processing. In the present invention, however, the native applications 460 need only be applications usable in the MFP 101 so there is no intention to limit them to the above-described application software. For example, the Web browser 440 to be described later is one of native applications. Such applications provided in the MFP 101 in advance will be referred to as native applications hereinafter. On the other hand, applications provided by the Web server 103 will be referred to as Web applications.

The execution unit, 461 executes main processing of the application. In the above-described examples, execution targets are copy processing, scan processing, and send processing. The screen display unit 462 displays, on the operation unit 219, an operation screen that causes the user to input settings necessary for execution of the execution unit 461. Note that the operation screen is not provided by the Web server 103 but displayed based on information held in the MFP 101 and read out by the native application 460. The screen displayed based on information held in the MFP 101 in advance will be referred to as a native screen hereinafter.

The action data management unit 463 exchanges action data with the action data-recording unit 464. Although details will be described later, action data is individual setting information of each application. In, for example, a copy application, action data represents setting information such as the number of copies and print density. Note that data handled by the action data-recording unit 464 is stored in, for example, the HDD 214. The action execution control unit 465 reads action data received from the action data management unit 463, generates a set operation screen in which each setting item is already set, and provides it to the screen display unit 462. The action deletion control unit 466 requires the action data management unit 463 to delete target action data, and receives a deletion result.

The custom menu 470 includes a button registration control unit 471, button execution control unit 472, button deletion control unit 473, screen display unit 474, button data management unit 475, and button delete-capability determination unit 477. The custom menu 470 implements a mechanism for registering a set value of various kinds of applications usable in the MFP 101 in association with one button, thereby constructing an operation screen desired by the user. This embodiment copes with, as the various applications usable in the MFP 101, not only the conventional native applications but also the Web application.

The button registration control unit 471 is invoked by the native application 460. At this time, the button registration control unit 471 sends a button data registration request to the button data management unit 475, and receives a button registration result. Although details will be described later, button data includes a number to identify a button, an application corresponding to the button, an action ID representing the number of action data, an icon representing the outer appearance of the button, group information, and a button name.

The button execution control unit 472 notifies the native application 460 corresponding to the selection target button of the action IC included in the button data. The button deletion control unit 473 obtains button data from the button data management unit 475. The button deletion control unit 473 then requests the native application 460 to delete corresponding action data, and receives the action data deletion result. If deletion has succeeded, the button deletion control unit 473 requests the button data management unit 475 to delete corresponding button data.

The screen display unit 474 displays, on the operation unit 219, an operation screen to be used by the user to execute a registered button or delete button data. The button data management unit 475 exchanges (registers and deletes) button data with the button data-recording unit 476. The button delete-capability determination unit 477 determines in advance whether button data is deletable for button data deletion by the button deletion control unit 473. Note that the custom menu 470 need not always include all the above-described constituent elements.

The Web browser 440 includes a communication unit 441, analyzing unit 442, and screen display unit 443. The communication unit 441 communicates with a presentation unit 412 of the Web application 410 via a communication unit 411 of the Web application 410 in accordance with the HTTP protocol. More specifically, the communication unit 441 requests an operation screen to be displayed on the Web browser 440 from the Web application 410, or notifies the Web application 410 of a user instruction input via the operation screen displayed on the Web browser.

The analyzing unit 442 analyzes an HTML file received from the Web application 410. The HTML file includes a description representing the contents of an operation screen to be displayed on the Web browser. The Web browser 440 is one of the above-described native applications, and includes the same arrangement as described concerning the native application 460. More specifically, the Web browser 440 includes an action data management unit 444, action execution control unit 446, action deletion control unit 447, action data control unit 448, and action data-recording unit 445.

The screen display unit 443 displays an operation screen on the operation unit 219 based on the analysis result of the analyzing unit 442. A screen thus displayed based on screen information (HTML file) received from the Web server will be referred to as a Web browser screen.

On the other hand, the Web server 103 includes the Web application 410. The Web application 410 includes communication units 411 and 414, presentation unit 412, address analyzing unit 413, and logic unit 415. The presentation unit 412 communicates with the communication unit 441 of the Web browser 440 via the communication unit 411 so as to send an operation screen to be displayed on the Web browser 440 to the MFP 101 in accordance with a request from the MFP 101. The presentation unit 412 also receives, from the MFP 101, a user instruction input via the operation screen displayed on the Web browser 440.

Upon receiving an instruction from the MFP 101, the Web application 410 executes various kinds of processing in accordance with the contents of the instruction, and requests the MFP 101 to execute processing. More specifically, the Web application 410 requests execution of print processing by the printer 220 of the MFP 101, execution of read processing by the scanner 221, or execution of send processing via the network I/F 218. To request the MFP 101 to execute processing, the logic unit 415 communicates with a communication unit 451 in the service provider 450 provided in the MFP 101 via the communication unit 414. The service provider 450 includes the communication unit 451 and a job generation unit 452. The communication unit 451 receives, via the communication unit 414, a processing request generated by the logic unit 415. The job generation unit 452 generates a job from information received by the communication unit 451, and outputs it to the native application 460.

As described above, the MFP 101 according to the embodiment can execute the Web application (external application) to be executed using information obtained from the Web server 103 serving as an external apparatus, and a native application (second application) to be executed using information held in advance. The MFP 101 has a custom menu function of allowing the user to construct a desired menu screen. The custom menu according to the embodiment can selectively display shortcut keys of the above-described Web application and native application.

<Data Format>

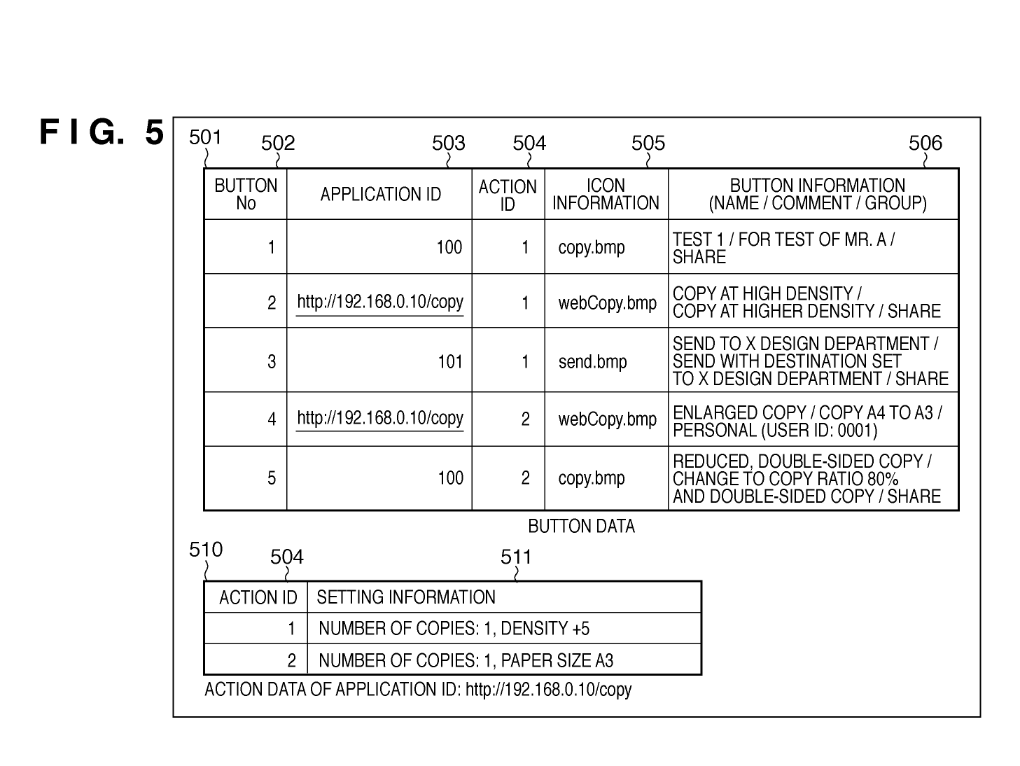

Examples of the data formats of button data 501 and action data 510 will be described next with reference to FIG. 5. The button data 501 includes a button No 502, application ID 503, action ID 504, icon information 505, and button information 506. Note that the button data 501 is managed by the custom menu 470.

The button No 502 is a number that uniquely identifies the button data 501 and is automatically assigned by the custom menu 470 upon button registration. The application ID 503 is a number that uniquely identifies the application. The application ID 503 is uniquely assigned by the custom menu 470 for each of the native applications 460 and the Web applications at the time of application installation. Note that for a Web application, the address where the Web application operates may be registered as the ID, as shown in FIG. 5. For example, an application whose application ID 503 is “100” is a copy application that is a native application. An application whose application ID 503 is “http://192.168.0.10/copy” is a copy Web application that is a Web application. Note that for a Web application, a Web browser may be registered in the application ID 503 by operating from the browser. In this case, the browser manages the URL of the Web application.

The icon information 505 represents an icon file name representing the outer appearance of the button displayed on the operation unit 219 via the screen display unit 474 of the custom menu 470. The button information 506 represents the button name, comment, and group. Note that the groups are roughly classified into my button as a personal button and a group button commonly usable among users.

The action data 510 includes setting information 511 together with the above-described action ID 504. Note that the action data 510 is managed for each application. The action ID 504 is a number that uniquely identifies action data and is assigned by each application. The setting information 511 includes various set values for each application. For example, setting information corresponding to the application ID 503 “http://192.168.0.10/copy” and the action ID 504 “1” represents contents including, as set values, number of copies “1” and density “+5”, as shown in FIG. 5. In this way, the button data 501 and the action data 510 are associated with each other via the action ID 504. For example, upon detecting press of the button corresponding to the button No 502 “2”, the custom menu 470 requests an operation screen in which the contents (number of copies “1” and density “+5”) corresponding to the action ID 504 “1” are set from the Web application, and displays it on the operation unit 219.

As described above, in this embodiment, not only the buttons of native applications but also the buttons of Web applications can be registered on an operation screen in the custom menu screen. This allows the user to easily construct a desired custom menu screen without concern for whether the application to be registered in the custom menu screen is a native application or Web application.

<Example of Screen>

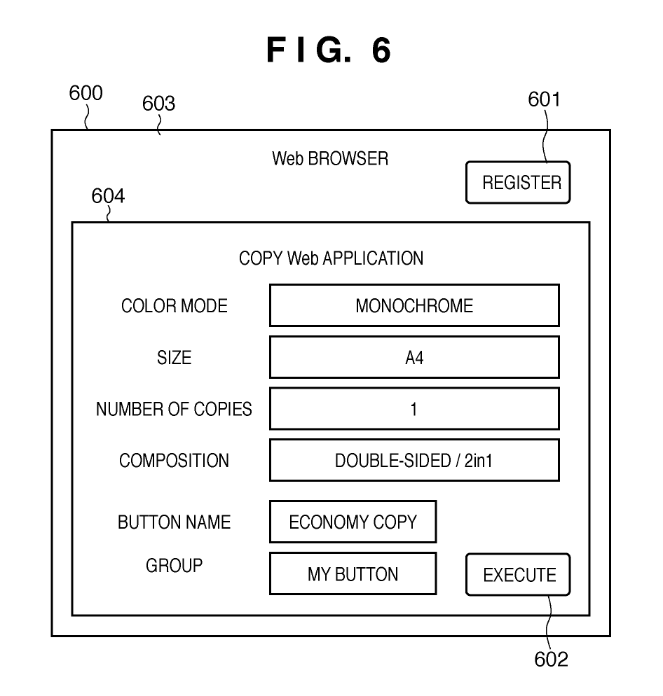

An example of a Web browser screen 600 displayed on the operation unit 219 will be described here with reference to FIG. 6. The Web browser screen 600 shown in FIG. 6 includes an operation screen 604 of a copy Web application and an operation screen 603 displayed by the Web browser 440. The operation screen 604 of the copy Web application includes an execution button 602 in addition to setting items (color mode, size, number of copies, composition, button name, and group). On the other hand, the screen 603 displayed by the Web browser 440 includes a registration button 601. That is the Web browser screen 600 includes the operation screen 604 provided by the Web application 410 in the Web server 103, and the operation screen 603 provided by the Web browser 440.

The registration button 601 is a button to be used to register the currently running Web application on the custom menu screen, and is provided by the Web browser 440. On the other hand, the execution button 602 is used to execute processing of the currently running Web application, and is provided by the Web application 410. When the registration button 601 is pressed, the information currently set on the operation screen 604 is read out. Buttons (custom buttons) to perform the same operation as that performed by pressing the execution button 602 of the setting information are generated and registered on the custom menu screen. According to the embodiment, it is possible to add custom buttons to execute a Web application to the custom menu screen by displaying the above-described Web browser screen 600.

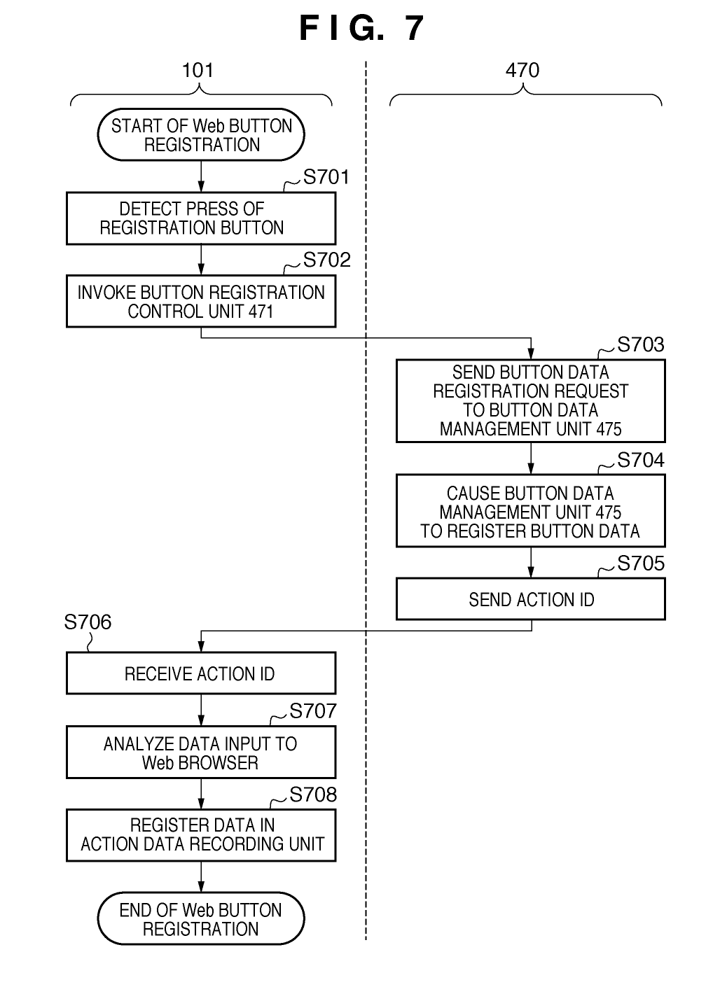

Note that although an arrangement for adding the registration button 601 to the Web browser screen 600 that is being executed by a Web application has been described here, the registration button may be displayed together with a native screen that is being executed by a native application, as a matter of course. In this case as well, when the registration button is pressed, the custom buttons of the native application are added to the custom menu, as in processing to be described with reference to FIG. 7.

<Registration Procedure>

The procedure of processing of registering buttons for a Web application from the Web browser 440 of the information processing system 100 according to the embodiment will be described next with reference to FIG. 7. The processing to be explained below is implemented by causing the CPU 211 of the MFP 101 to read out a program stored in the ROM 212 or the HDD 214 to the RAM 213 and execute the program. Note that in FIG. 7, the left side of the dotted line indicates processing of the Web browser 440, and the right side of the dotted line indicates processing of the custom menu 470. The following processing procedure starts from a state in which the screen display unit 443 serving as a first display control means displays the Web browser screen 600 on the operation unit 219.

In step S701, upon detecting press of the registration button 601 on the Web browser screen 600, the. Web browser 440 starts button registration processing. In step S702, the Web browser 440 invokes the button registration control unit 471 of the custom menu 470.

In step S703, the button registration control unit 471 requests the button data management unit 475 to register the button data 501, and receives the button registration result. In step S704, the button data management unit 475 stores the button data 501 in the button data-recording unit 476. The stored button data 501 includes a number to identify the button, an application corresponding to the button, the action ID 504 representing the number of the action data 510, the icon information 505 representing the outer appearance of the button, and the button information 506 having group information and button name. When storage of the button data 501 is completed, the button execution control unit 472 notifies the native application (in this case, the Web browser 440) corresponding to the selection target button of the action ID included in the button data 501 in step S705.

In step S706, the Web browser 440 receives the action ID 504. In step S707, the Web browser 440 causes the analyzing unit 442 to analyze the setting information currently input to the operation screen and convert it into data recordable in the action data-recording unit 445. In step S708, the Web browser 440 causes the action data management unit 444 to register the action data 510 in the action data-recording unit 445 together with the action ID 504 received in step S706.

<Execution Procedure>

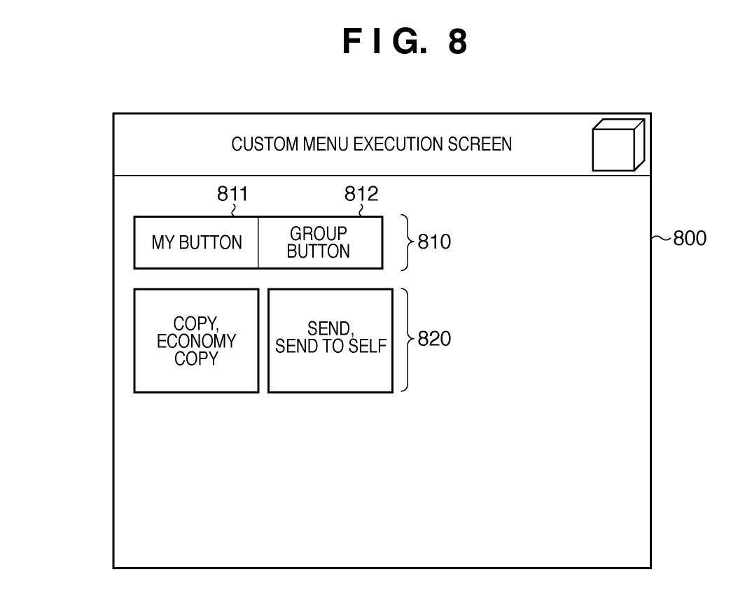

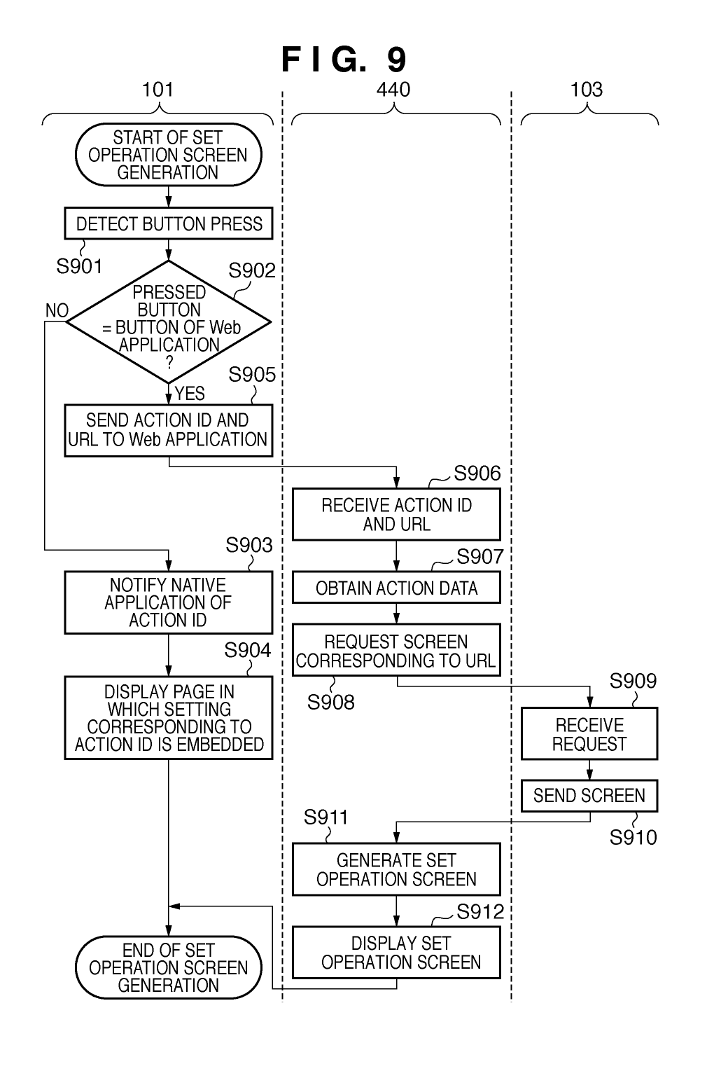

Processing to be executed when a registered button is selected from an operation screen (custom menu screen) 800 of the custom menu 470 in the MFP 101 will be described next with reference to FIGS. 8 and 9. First, an example of the operation screen 800 displayed on the operation unit 219 to execute a registered button of the custom menu 470 will be explained with reference to FIG. 8. The operation screen 800 of the custom menu 470 includes a group selection portion 810 and a button selection portion 820. The group selection portion 810 is an interface to select the type of buttons to be displayed on the operation screen 800. Note that in this embodiment, the button types selectable by the group selection portion 810 are a my button 811 and a group button 812. However, it is not intended here to limit the groups to these two types. The button selection portion 820 shown in FIG. 8 indicates a state in which the my button 811 is selected. The button selection portion 820 displays registered buttons for each group type. In this embodiment, for example, an economy copy button and a send-to-self button registered by the processing described with reference to FIG. 7 are displayed.

The procedure of processing to be executed upon detecting press of a button on the operation screen 800 will be described next with reference to FIG. 9. The processing to be explained below is implemented by causing the CPU 211 of the MFP 101 to read out a program stored in the ROM 212 or the HDD 214 to the RAM 213 and execute the program. The following processing procedure starts from a state in which activation processing of the custom menu 470 interrupts the CPU 211 upon pressing the custom menu screen activation button displayed on the operation unit 219 so that the screen display unit 474 serving as a second display control means displays the operation screen 800 on the operation unit 219.

In step S901, the operation unit 219 detects the user pressing a button registered on the custom menu screen, and notifies the CPU 211 of the button press. The CPU 211 notifies the custom menu 470 of the button press. The custom menu 470 invokes processing corresponding to the button press.

In step S902, the custom menu 470 determines whether the application corresponding to the pressed button is a native application or a Web application. More specifically, the custom menu 470 causes the button execution control unit 472 to obtain the button data 501 of the pressed button from the button data management unit 475, and confirms the application ID 503 of the obtained button data 501. If a URL is described in the application ID 503, the application is determined as a Web application, and otherwise, as a native application. If the application ID 503 corresponding to the pressed button indicates a native application, the process advances to step S903. If it indicates a Web application, the process advances to step S905.

In step S903, the custom menu 470 notifies the corresponding native application 460 of the action ID 504 of the button data 501 obtained by the button execution control unit 472. In step S904, the action execution control unit 465 of the native application 460 obtains the action data 510 corresponding to the action ID 504 from the action data management unit 463. The action execution control unit 465 sets each setting item of the operation screen based on the setting information of the obtained action data 510. Additionally, the screen display unit 462 displays the set operation screen generated by the action execution control unit 465 on the operation unit 219. The processing to be executed when the button of a native application is pressed has been described above.

On the other hand, if the pressed button is of a Web application, the button execution control unit 472 sends the application ID 503 and the action ID 504 to the Web browser 440 in step S905. In step S906, the Web browser 440 receives the application ID 503 (in this case, URL information) and the action ID 504. In step S907, the action data management unit 444 obtains the action data 510 corresponding to the action ID 504. In step S908, the Web browser 440 requests a screen of the Web server 103 based on the URL information received in step S906.

The Web server 103 receives the request from the Web browser 440 in step S909, and sends screen information corresponding to the URL to the Web browser 440 in step S910. In step S911, the action data control unit 448 of the Web browser 440 receives the screen information, and generates a set operation screen based on the action data 510. More specifically, the action data control unit 448 generates an HTML file that validates attributes representing selection of tags each having a list box or radio button input function and a value attribute corresponding to each setting information of the action data 510. For example, for a list box, the selected attribute of the option tag is designated. For a radio button, the checked attribute of the input tag is designated. Then, in step S912, the screen display unit 443 displays the set operation screen on the operation unit 219 based on the HTML file analysis result of the analyzing unit 442. The processing to be executed when the button of a Web application is pressed has been described above.

As described above, the information processing apparatus according to the embodiment displays the registration button configured to add, to the custom menu, custom buttons to be executed based on the current setting information of the currently running application during display of the operation screen of a Web application or a native application. When the registration button is pressed, the information processing apparatus manages button data and action data in association with each other as the information of custom buttons to be added to the custom menu. When the user instructs to display the custom menu, the information processing apparatus generates the custom menu including the custom buttons using the button data and action data, and displays it. When the user presses an arbitrary custom button of the custom menu, the information processing apparatus displays an operation screen following the setting information upon registering the custom button using the button data and action data. For example, when a custom button concerning a Web application is pressed, the information processing apparatus requests information of an operation screen reflecting the setting information of an external apparatus that provides the Web application, and displays the operation screen. That is, the information processing apparatus according to the embodiment can register not only shortcut keys of native applications but also those of Web applications on a custom menu that allows the user to construct a desired menu. Hence, the information processing apparatus can provide a user-friendly operation system because the user can construct a custom menu without being conscious of native applications and Web applications.

### Second Embodiment

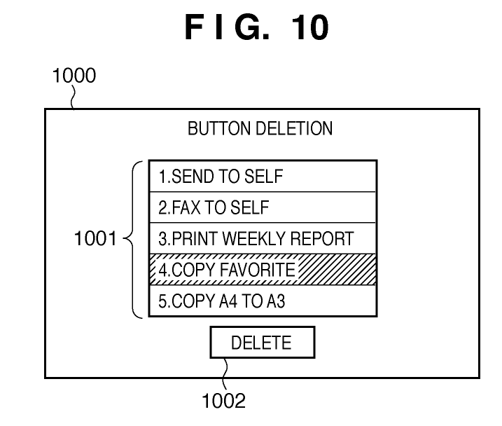

The second embodiment of the present invention will be described below with reference to FIGS. 10 to 12. In this embodiment, a series of processes of deleting a registered button from the operation screen of a custom menu 470 of an MFP 101 will be explained. Note that the overall arrangement of an information processing system 100 according to the embodiment, the arrangement of the MFP 101, the arrangement of a Web server 103, the control arrangement of the entire information processing system 100, the structure of button data 501, and the structure of action data 510 are the same as in the first embodiment, and a description thereof will not be repeated.

An example of an operation screen 1000 displayed on an operation unit 219 to delete a registered button from a custom menu screen will be described first with reference to FIG. 10. The operation screen 1000 includes a deletion button selection portion 1001 and a button deletion button 1002. The deletion button selection portion 1001 is an interface to select a button to be deleted. In FIG. 10, the “4. copy favorite” button is selected. Upon detecting press of the button deletion button 1002, the custom menu 470 invokes processing of deleting the button selected in the deletion button selection portion 1001.

<Deletion Procedure>

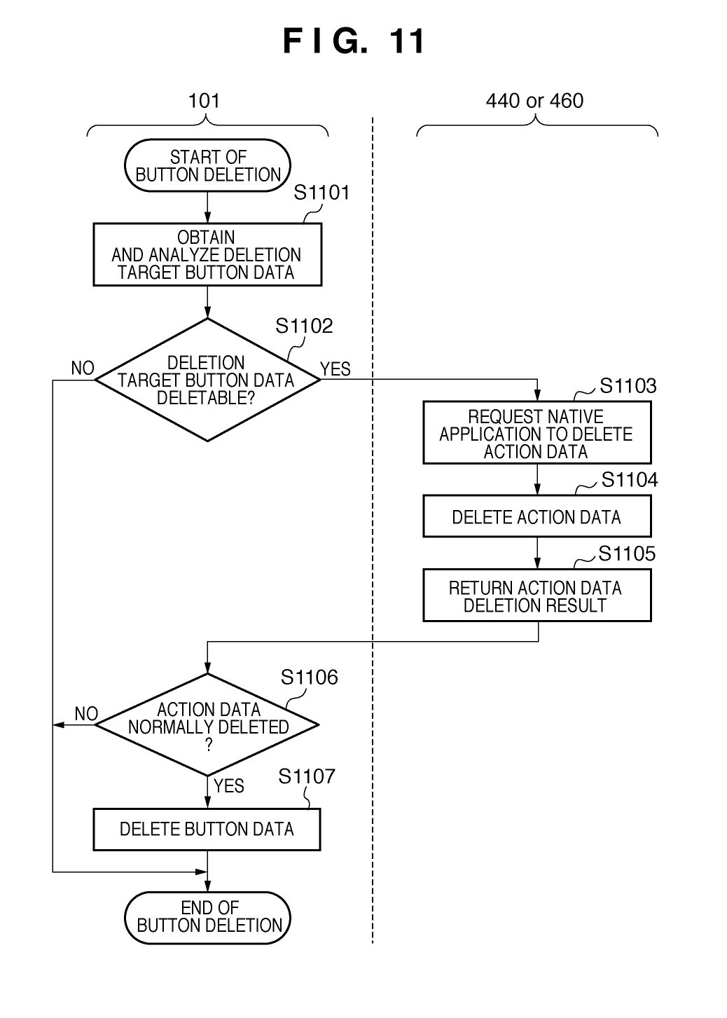

The procedure of processing of deleting a registered button via the operation screen 1000 for button deletion of the custom menu 470 according to the embodiment will be described next with reference to FIG. 11. The following processing procedure starts from a state in which a CPU 311 detects press of the button deletion button 1002 of the operation screen 1000 displayed on the operation unit 219 by a screen display unit 474 functioning as a third display control means, and notifies the custom menu 470 of the press of the button deletion button 1002.

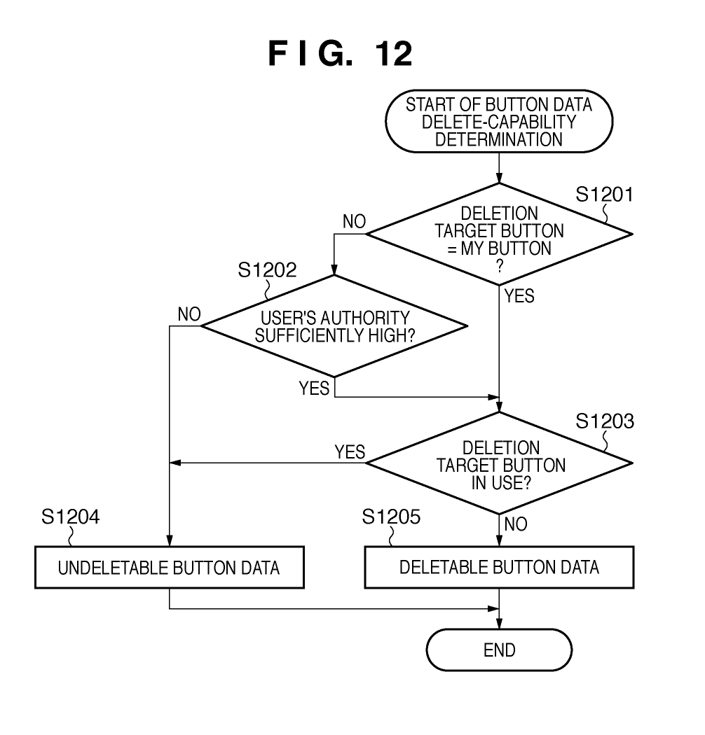

In step S1101, a button deletion control unit 473 of the custom menu 470 obtains the corresponding button data 501 from a button data management unit 475 in accordance with press of the button deletion button 1002, and analyzes the obtained button data 501. In step S1102, the button deletion control unit 473 inquires of a button delete-capability determination unit 477 to determine whether the obtained button data 501 is deletable. Processing of the button delete-capability determination unit 477 will be described later with reference to FIG. 12. If the button data is deletable, the process advances to step S1103. Otherwise, the processing ends.

In step S1103, the button deletion control unit 473 extracts a corresponding application ID 503 from the analyzed button data 501, and requests the corresponding application to delete the action data 510. The button deletion control unit 473 also requests the native application or Web browser 440 corresponding to the application ID 503 to delete the action data 510. At this time, the button deletion control unit 473 adds an action ID 504 of the action data to be deleted to the request.

In step S1104, an action deletion control unit 466 or 447 receives the request, and requests an action data management unit 463 or 444 to delete the action data 510 based on the action ID 504 added to the request. The action data management unit 463 or 444 receives the request, and deletes the action data 510 from an action data-recording unit 464 or 445. In step S1105, the action deletion control unit 466 or 447 obtains the deletion result (success or failure) from the action data management unit 463 or 444, and returns the deletion result to the custom menu 470.

In step S1106, the button deletion control unit 473 analyzes the deletion result of the action data 510. If deletion of the action data 510 has succeeded, the process advances to step S1107. If deletion has failed, the processing ends without deleting the corresponding button data 501. In step S1107, the button deletion control unit 473 deletes the button data 501 because deletion of the action data 510 has succeeded. More specifically, the button deletion control unit 473 requests the button data management unit 475 to delete the target button data 501. Upon receiving the request, the button data management unit 475 deletes the button data 501 from a button data-recording unit 476.

The procedure of processing of determining the delete-capability of the button data 501 in step S1102 will be described next with reference to FIG. 12. As described above, in step S1102, the button deletion control unit 473 inquires of the button delete-capability determination unit 477 about whether the button data 501 is deletable. Processing of the button delete-capability determination unit 477 corresponding to the inquiry in step S1102 will be described below.

In step S1201, the button delete-capability determination unit 477 confirms the group of the button data 501 of the deletion target. If the group is a my button 811, the process advances to step S1203. If the group is a group button 812, the process advances to step S1202. In step S1202, the button delete-capability determination unit 477 confirms whether the user who requests deletion has a sufficiently high access right to the permission of the deletion target button. More specifically, for example, if the user is the administration user of the MFP 101, the group button 812 is deletable. However, if the user is a general user, the group button is undeletable. That is, if the access right of the user who requests deletion is sufficiently high, and the button is deletable, the process advances to step S1203. Otherwise, the process advances to step S1204 to determine that the button is undeletable.

In step S1203, the button delete-capability determination unit 477 determines whether the deletion target button is currently in use. If in use, the process advances to step S1204 to determine that the button is undeletable. Otherwise, the process advances to step S1205 to determine that the button is deletable, and the processing ends. Note that although the group of the button data 501, user's authority, and button execution status are used as the determination conditions, any other conditions concerning deletion may be used.

As described above, in this embodiment, the button data 501 and the action data 510 can be deleted from the custom menu 470 while maintaining the consistency of the two data. This prevents any omission of deletion of the button data 501 and the action data 510. In addition, the user can delete a button not only for a native application 460 but also for a Web application 410 from the MFP 101 at an arbitrary timing.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-283436 filed on Dec. 14, 2009, which is hereby incorporated by reference herein in its entirety.

1. An information processing apparatus capable of using an external application provided by an external apparatus, characterized by comprising:
first display control means for displaying, on a display unit, an operation screen of said external application and a registration button configured to register, in a custom menu, a custom button that causes a currently running application to execute processing based on current setting information;
storage means for, when the registration button is pressed, analyzing the setting information currently input to the operation screen and storing, in a storage device, button data concerning the custom button and action data concerning the current setting information in association with each other; and
second display control means for, upon receiving an instruction to display the custom menu, reading out the button data and the action data from the storage device, generating the custom menu including the custom button corresponding to the readout button data and action data, and displaying the custom menu on the display unit.

2. The apparatus according to claim 1, characterized in that said second display control means further comprises request means for, when the custom button associated with the external application displayed on the custom menu is pressed, requesting said external apparatus to provide screen information using the button data and action data corresponding to the custom button.

3. The apparatus according to claim 2, characterized in that using the screen information requested by said request means, said second display control means displays, on the display unit, the operation screen of the external application in which setting information set upon pressing the registration button is set.

4. The apparatus according to claim 1, characterized by further comprising:
third display control means for displaying the custom button registered in the custom menu to be selectable and displaying, on the display unit, a deletion button configured to delete the selected custom button; and
deletion means for, when the deletion button is pressed, deleting the button data and action data corresponding to the selected custom button from the storage device.

5. The apparatus according to claim 4, characterized in that only when a user who has pressed the deletion button has authority to delete the custom button, and the custom button is not in use, said deletion means deletes the corresponding button data and action data from the storage device.

6. A method of controlling an information processing apparatus capable of using an external application provided by an external apparatus, characterized by comprising:
causing first display control means to display, on a display unit, an operation screen of the external application and a registration button configured to register, in a custom menu, a custom button that causes a currently running application to execute processing based on current setting information;
causing storage means to, when the registration button is pressed, analyze the setting information currently input to the operation screen and store, in a storage device, button data concerning the custom button and action data concerning the current setting information in association with each other; and
causing second display control means to, upon receiving an instruction to display the custom menu, read out the button data and the action data from the storage device, generate the custom menu including the custom button corresponding to the readout button data and action data, and display the custom menu on the display unit.

7. A computer-readable storage medium storing a computer program which causes a computer to execute an information processing apparatus control method of claim 6.
